(19) United States
(12) Patent Application Publication
(10) Pub. No.: US 2002/0184193 A1
(43) Pub. Date: Dec. 5, 2002

(54) Method and system for performing a similarity search using a dissimilarity based indexing structure

(76) Inventor: Meir Cohen, Kiryat-Ono (IL)

Correspondence Address: PENNIE & EDMONDS LLP, COUNSELLORS AT LAW, 1155 Avenue of the Americas, New York, NY, 10036-2711, US

(21) Appl. No.: 09/867,774

(22) Filed: May 30, 2001

(51) Int. Cl. G06F 7/00

(52) U.S. Cl. 707/3

(57) ABSTRACT

A system and method for constructing an indexing structure and for searching a database of objects is disclosed. The database preferably contains a plurality of indexed multimedia objects, where objects that are dissimilar or substantially orthogonal correspond to the same index. The search for similar objects is performed by calculating an angle between the index and a vector representing the query object. Objects corresponding to indices at an angle from the query vector outside of determined bounds are not searched further, thus reducing the number of items to be searched and the search time. A binary search of multimedia objects is performed using the index structure.

### FIELD OF THE INVENTION

The present invention relates to the field of automatic pattern classification, more particularly to the classification of media objects such as electronic representations of audiovisual works.

### BACKGROUND OF THE INVENTION

Similarity Searching

It is frequently desirable to automatically determine whether a given media object (a digital representation of a recording or work of authorship, such as an audiovisual or multimedia work) is present in a large collection of such objects. More generally, it is frequently desirable to determine if a given media object is similar to another present in a collection, or if all or a portion of a given media object is similar to all or a portion of one or more media objects in the collection.

One approach is to perform a computerized search of the collection for an exact match between digital representations of the given media object and each member of the media collection. However, many media objects that human beings would classify as similar or even an exact match to the given media object will not have identical digital representations. There is thus a need for a “human-like” similarity search that will yield human-like results.

Current similarity search methods perform better than exact matching, but are unable to accurately classify objects as similar in every case that a human being would do so. Typical similarity search methods treat media objects as vectors in n-dimensional space ( [symbol] ⁿ) for some n. A similarity measure is defined for every pair of vectors in [symbol] ⁿ having values between 0 for dissimilar vectors and 1 for exactly matching vectors. By applying the similarity measure to vectors in the collection, a set of similar vectors may be determined.

Many such similarity search methods are known, generally including a model for classifying some range of deviations from a given query vector as similar. Some models of deviations from the query vector are based on cognitive psychophysical experimental results and attempt to formalize the concept of human similarity. Others are based on mathematical heuristics or on models of physical transformations and processes that are reflected in the media objects classified.

Similarity Measures

The most commonly used similarity search methods are those that are based on some metric in a vector space. The similarity between two vectors is proportional to the distance between them under the selected metric. Another method is to use the algebraic concept of inner product to measure the angle between two vectors determine similarity based on the angle.

When searching a large collection of media objects, one problem arises from the need to calculate the similarity measure for each object. Large processing resources are often required to compute a similarity measure, large memory resources are often required to store the collection, and large I/O overhead is often incurred to access each object of the collection from mass storage.

Indexing may be used to reduce the computational resources required to perform a similarity search over the collection. The indexing structure is typically based on an analysis of the relationships between the objects in the collection. Using indexing, only a relatively small number of similarity measure calculations need be performed to determine whether there are similar vectors in the collection. Computation of the indexing structure may also require large computational resources and it typically only provides savings when queries are performed many times.

One class of known indexing structures for metric based similarity search methods is referred to as metric trees, including the R-Tree, R*-Tree, R+-Tree, X-Tree, SS-Tree, and SR-Tree. Other types of known indexing structures include the vantage point tree, or VP-Tree, the multi-vantage point tree or MVP-TREE, the generalized hyperplane tree or GH-Tree, the geometric near-neighbor access tree or GNAT tree, the M-tree and the M2-Tree.

All of these indexing methods are based upon grouping objects in the collection together by similarity. Such methods suffer from the “curse of dimensionality.”Performance falls significantly as the number of dimensions increases, and is typically unacceptable when dimensions greater than approximately 20 are used.

Local neighborhoods of points in a high-dimensional space are likely to be devoid of observations. When extended to include a sufficient number of observations, neighborhoods become so large that they effectively provide global, rather than local, density estimates. To fill the space with observations, and thereby relieve the problem, requires prohibitively large sample sizes for high-dimensional spaces. For metric trees in sufficiently high-dimensional spaces, every page of the index is accessed for even small range queries. The performance under such circumstances is nearly equivalent to a sequential search, and the benefit of the index destroyed.

There is thus a need for a method and system that provides a “human-like” similarity measure, and a corresponding index that avoids the “curse of dimensionality”.

### SUMMARY OF THE INVENTION

The present invention is directed to efficient systems and methods for performing computerized similarity searches of a database or collection containing a plurality of objects, such as media objects, where the objects may be represented in the form of digital multidimensional vectors. In one preferred embodiment, the media objects are digital audio files, represented as multidimensional vectors wherein each dimension corresponds to a signal amplitude at a given sample time measured from the beginning of the recording. For example, a one-second long, 40 kilohertz sample-rate, 16-bit resolution digital audio file would preferably be represented as a 40,000 dimension vector, with each dimension having 2¹⁶ possible values. Any object represented as a vector may be indexed using the present invention.

Preferably, vectors representing objects in the collection are assigned to clusters based on dissimilarity as determined by a similarity measure. Vectors are assigned to clusters comprising other dissimilar vectors. In a preferred embodiment, a dot product or angle similarity measure is used, and vectors that are nearly orthogonal to each other are assigned to the same clusters. The clusters are preferably indexed by a cluster index vector comprising the sum of the vectors representing the objects associated with the cluster. For each vector in each cluster, a list of similar vectors, if any, is built from the plurality of the objects in the database.

To query the collection, the cluster index vectors are preferably first tested for similarity to the query vector. In a preferred embodiment, the test is based on the angle between the cluster index vector and the query vector. Clusters that are too dissimilar to the query vector, preferably clusters having cluster index vectors with angles relative to the query vector outside a calculated range, are not searched further. By means of the present invention, the number similarity comparisons required to locate the most similar vector in a collection is substantially reduced. A “human-like” similarity measure is provided, and the present invention works well with vectors of very high dimensionality, thus solving the dimensionality problem.

### DETAILED DESCRIPTION OF THE INVENTION

In one aspect, the present invention comprises a similarity measure M(x,y) based on the correlation between two sequences, or, treated as vectors, the inner product, and an associated indexing method called “C-Tree.” Dissimilarity clustering as described in this application may be based on any similarity or dissimilarity measure. In a preferred embodiment, a similarity measure comprising a metric is used.

To comprise a metric, a relation must satisfy three conditions: positivity, reflexivity, symmetry, and the triangle inequality. The inner product is not a metric because it is not always positive. The absolute value of the inner product is also not a metric because it does not satisfy the triangle inequality. However, if restricted to the upper half sub-space of the vector space then the absolute value of the inner product may be used as a metric. This similarity metric can then be used with known indexing structures for metric-based similarity search methods. Restriction to the upper half subspace of a vector space is acceptable for many types of media objects.

Another metric that can be used as a measure of similarity is the cosine of the angle between vectors

$$M ( x , y ) = \frac{< x , y >}{‖ x ‖ \cdot ‖ y ‖} = cos ( ∠ ( x , y ) ) , x , y , ∈ {R}^{n}$$

However, the absolute value of the inner product M(x,y)=|<x,y>| corresponds more closely to human estimates of similarity.

C-Tree: Insertion, Deletion and Search

The C-Tree indexing structure is based on creating multiple “layers” of clusters. Odd layers comprise clusters of dissimilar preferably, nearly orthogonal) vectors. Even layers comprise clusters of vectors, referred to as “friends” and “close friends,” that are similar to vectors in an adjacent odd layer above. Each odd layer comprises nonintersecting clusters. A search over the C-Tree structure is started from the first layer and may continue to deeper layers if needed.

Insertion

Insertion of a new vector, xε [symbol] ⁿ, into the C-Tree indexing structure is started in the first layer (an odd layer) and may continue to the next layer (an even layer) and deeper. Insertion of a new sample may affect many layers.

Odd Layer Insertion

Inserting x into an odd layer is performed as follows: If there exists a vector z in a cluster C in the current odd layer such that 1>1|M(z,x)|>1−δ then x will be inserted as a member in the next (even) layer as a close friend vector of z. δ is selected based on the amount of noise present in the system. If the signal-to-noise ratio of vectors is low (i.e. if noise is a large part of typical vectors) then δ is chosen near zero. If the signal-to-noise ratio is high (i.e. if noise is a small party of typical vectors) then δ may be chosen near 1. If there is no such close friend vector z to x, then:

I. If there is a cluster, C, in the current odd layer such that x is nearly orthogonal to every vector yεC, i.e. |M(y, x)|<ε for some threshold ε, then x is added to that cluster index vector I_{C}, i.e.

$${I}_{C} = {I}_{C} + \frac{x}{‖ x ‖} .$$

If there exists a vector z from a different cluster C^{/}≠C in the current odd layer such that 1≧|C(z,x)|>1-2·δ then x will also be inserted as a member in the next (even) layer as a friend of z.

II. If there is no cluster, C, in the current odd layer such that x is nearly orthogonal to every vector y in C and x is not a close friend of any other vector in the current odd layer then we add a new cluster C, to the current odd layer and set the cluster index vector for C:

$${I}_{C} = \frac{x}{‖ x ‖} .$$

Thus, for every cluster C,

$$C = {\sum }_{i = 1}^{m} \frac{{x}_{i}}{‖ {x}_{i} ‖} ⇔ \vert M ( {x}_{k} , {x}_{l} ) \vert < ε , ∀ k \neq l , l \leq k , l \leq m \leq n$$

Even Layer Insertion

A vector, x, is inserted into an even layer only as a friend or close friend of a vector z from the previous odd layer as described in connection with odd layer insertion above. There are preferably no clusters in even layers. As used herein, “cluster” refers only to a set of associated dissimilar (preferably nearly orthogonal) vectors.

Insertion in Odd Layer Below an Even Layer

For each friends list or close friends list of a vector z in an even layer, a cluster is added to the next odd layer below. For each friend or close friend of z, the difference vector (z−x) is added to the cluster, as described above for odd layer insertion. Many of the difference vectors will be orthogonal to each other because they are differences of similar vectors. New odd and even layers are created recursively until all friends lists and close friends lists in the lowest even layer have relatively few members so that a linear search of the lists is practical. Preferably, layers are created until the largest friends lists and close friends lists have fewer than approximately ten members.

Deletion

To delete a vector x, the vector is first located by searching as described below. If it is a friend or close friend vector, it is removed from the list. If the vector to be deleted is included in a cluster, then it is subtracted from the corresponding cluster index vector, i.e.

$${I}_{C} = {I}_{C} - \frac{x}{‖ x ‖} .$$

The layers below are recursively traversed and the contribution of the deleted vector to the layers below is similarly reversed.

Search

Using a preferred similarity measure, we say that y is similar to x if:

—cos⁻¹(1−δ)≦ [symbol] cos⁻¹(1−δ)

Assuming that there exists some cluster C in the first (odd) layer such that x is in C, if y is similar to x then the angle between y and I_{C} is bounded:

[symbol]

(x,I_{C})− [symbol] (y,x)≦ [symbol] (y,I_{C})≦ [symbol] (x,I_{C})+ [symbol] (y,x)

$$\frac{1 - ( m - 1 ) \cdot ε }{\sqrt{m} \cdot \sqrt{1 + ( m - 1 ) \cdot ε }} \leq cos ( ∠ ( x , {I}_{C} ) ) \leq \frac{1 + ( m - 1 ) \cdot ε }{\sqrt{m} \cdot \sqrt{1 - ( m - 1 ) \cdot ε }}$$

where m is the number of vectors in cluster C. ε is preferably chosen based on m, in a preferred embodiment, ε is approximately 1/10^{m}, but larger values may be chosen if too many clusters are produced. Thus, if y is similar to x the angle between y and _{C} is bounded by the following index inequality:

$${cos}^{- 1} ( \frac{1 + ( m - 1 ) \cdot ε }{\sqrt{m} \cdot \sqrt{1 - ( m - 1 ) \cdot ε }} ) - {cos}^{- 1} ( 1 - δ ) \leq ∠ ( y , {I}_{C} ) \leq {cos}^{- 1} ( \frac{1 - ( m - 1 ) \cdot ε }{\sqrt{m} \cdot \sqrt{1 + ( m - 1 ) \cdot ε }} ) + {cos}^{- 1} ( 1 - δ )$$

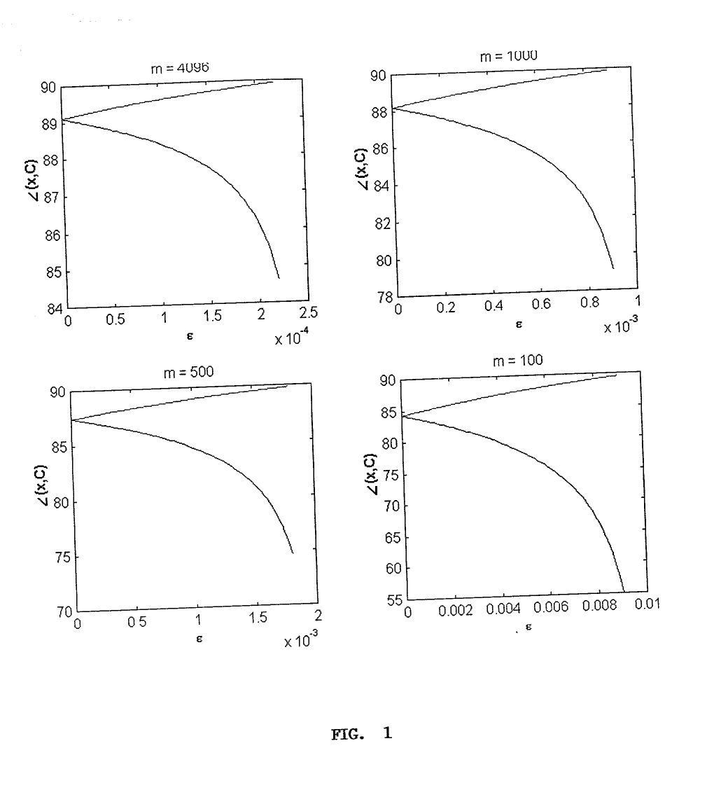

If the foregoing index inequality does not hold, then there is no x in C such that x and y are similar. Therefore, if the angle between y and I_{C} do not satisfy the index inequality, there is no vector in cluster C similar to y and C need not be searched further. Since ε and m are known and δ is given, the inequality is straightforward to calculate. The relationship between m, [symbol] (y, C) and ε is illustrated in FIG. 1.

If the index inequality is satisfied for a cluster C, a binary search for y is preferably conducted as follows. C is split into two complementary sub-clusters C′ and C″ such that each sub-cluster comprises half of the vectors in the source cluster, C, with no vectors in common. Because clusters (and their subclusters) are sets of nearly orthogonal vectors, any two sub-sets of vectors having approximately equal numbers such that C=C′∪C″ and C′∩C″=Ø may be selected. The index inequality above is then calculated for [symbol] (y,I_{C}_{^{/}}) and [symbol] (y,I_{C}_{^{//}}). Any subcluster that does not satisfy the index inequality need not be searched further. Because C′ and C″ are smaller than C, m is smaller and a smaller range is bounded by the inequality.

Subclusters that satisfy the inequality are recursively split into further subclusters, their subcluster index (vector sum) is calculated, and tested against the index inequality. The recursion is stopped when no subcluster satisfies the index inequality or when a sub-cluster comprising only a single vector x similar to y is found. If x is found to be similar to y, then the friends and close friends of x in the next even layer are tested for similarity to (x-y) as follows.

If a result vector x is located having one or more friend or close friend vectors in the next even layer, then the next odd layer is searched using the binary search described above to determine which friend or close friend vector most closely matches the vector (x-y). This process is repeated recursively until a match is found. If the result vector q is a close friend vector then the previous odd layer is checked to determine if this vector has a friends list in the next even layer. If so, then the odd layer is searched for more matching vectors.

The first layer of the C-tree is searched first for a cluster, and then the cluster is searched using a binary search described above to find a single vector similar to the query vector. Then friend and close friend vectors in the even layer are searched to determine a cluster in the next odd layer to search. The process is repeated recursively until a match is found.

If no sub-cluster can be found that satisfies the index inequality, then the next cluster in the first (odd) layer that satisfies the index inequality is searched. If no cluster satisfies the index inequality, then no vector similar to the query vector is in the collection.

A system for performing the foregoing method is preferably implemented in C++ using a threading package such as pthreads for multithreaded searching. Other languages or systems may be used. Implementing the indexing structure and similarity measure is well within the skill of those working in the multimedia database arts. A preferred system comprises a non-volatile storage system for media objects, such as a high-bandwidth disk system, preferably an Ultra-160 RAID-S array and an electronic processor, preferably a multiprocessing digital computer such as a four-processor Intel Xeon system with large cache and 64-bit PCI slots. One preferred alternative comprises a special purpose digital signal processing integrated circuit. Preferably, sufficient RAM is provided to store a large number of cluster index vectors in RAM during searching.

In a preferred embodiment, the indexed media objects comprise digital audio files having a vector representation comprising one dimension per sample. Thus for example, a 1 second 40 kilohertz sample rate, 16-bit resolution digital audio clip is represented as a 40,000 dimension vector. Other embodiments comprise digital video files, text files, still photographs, and other works of authorship.

What is claimed:

1. A system for classifying media objects, comprising:
an electronic storage medium containing a plurality of media objects;
an electronic processor configured to associate one or more subsets of the plurality of media objects into one or more clusters of dissimilar objects and to calculate at least one index of at least one cluster;
the electronic processor being further configured to calculate the similarity of a query vector with the at least one index.

2. A method for constructing an index structure for a database comprising the steps of:
associating an electronic representation of a vector with a cluster of such representations and an index to which the vector is dissimilar, the index comprising the sum of the vectors of the cluster;
adding the representation of the vector to the index;
searching the database by measuring the similarity of a query vector to the index.

3. The method of claim 2 wherein the vector is a multimedia object.

4. The method of claim 2 wherein the vector and the index are substantially orthogonal.

5. The method of claim 2 wherein the vector is a digital signal.

6. A method for searching a database for a similar object comprising the steps of:
electronically calculating a similarity measure of an index and a query vector;
electronically comparing the similarity measure with a calculated range;
searching a plurality of dissimilar vectors associated with the index if the similarity measure is within the range;
not searching the plurality of dissimilar vectors associated with the index if the similarity measure is not within the range.

7. The method of claim 5 further comprising the steps of:
dividing the plurality of vectors into two or more sets without intersection;
calculating set indices for each of the two or more sets;
calculating the similarity measure of the set indices and the query object; and
searching only those of the two or more sets for which the similarity measure is within a second range calculated based on the number of vectors in at least one of the two or more sets.
